(19) United States
(12) Patent Application Publication
(10) Pub. No.: US 2025/0014801 A1
(43) Pub. Date: Jan. 9, 2025

(54) PLANAR TRANSFORMER

(71) Applicant: CHICONY POWER TECHNOLOGY CO., LTD., New Taipei City (TW)

(72) Inventor: Hsiang-Chueh MENG, New Taipei City (TW)

(21) Appl. No.: 18/465,408

(22) Filed: Sep. 12, 2023

(30) Foreign Application Priority Data
Jul. 4, 2023 (TW) 112124922

(51) Int. Cl. H01F 27/26; H01F 27/28

(52) U.S. Cl. CPC H01F 27/26; H01F 27/28

(57) ABSTRACT

A planar transformer includes a first magnetic core, a second magnetic core, and a circuit board. The first magnetic core includes a base, a first magnetic column, a second magnetic column, and a third magnetic column. The circuit board includes a first side, a second side, and a through hole. The through hole is sleeved on the second magnetic column, and the first side and the second side are protruding from the first magnetic core. The first magnetic core is connected with the second magnetic core, and the circuit board is disposed between the first magnetic core and the second magnetic core. At least one separation component is disposed between the first magnetic core and the second magnetic core, or the first magnetic core and/or the second magnetic core have a plurality of separation components.

### BACKGROUND

### Technical Field

The present disclosure relates to a planar transformer, and more particularly to a planar transformer having at least one separation component.

### Description of Related Art

The statements in this section merely provide background information related to the present disclosure and do not necessarily constitute prior art.

Many electrical appliances use transformers to convert the input voltage to the appropriate output voltage required. A general transformer includes a high-voltage-side coil and a low-voltage-side coil, wherein the high-voltage-side coil receives alternating current (AC) power to generate a magnetic field, and the low-voltage-side coil generates an induced potential difference in response to the generated magnetic field. Therefore, the transformer acquires the conversion of the output voltage and the input voltage corresponding to a turns ratio through the turns ratio between the high-voltage-side coil and the low-voltage-side coil.

However, with the demand for miniaturization of the electrical appliance, the volume of the transformer used needs to be reduced accordingly. Compared with traditional transformers, the planar transformers are characterized by their smaller volume. Therefore, the proportion of using the planar transformers has increased in electrical applications where space is limited or miniaturization is required.

Since the application of planar transformers and planar boost inductors in power supplies belongs to the technology of energy storage and conversion modules, and the planar transformer design can increase efficiency and the space utilization of components on the motherboard, it can significantly increase the power density of the power supply. Furthermore, since the planar transformer has the characteristics of high temperature resistance and easy heat dissipation, it is widely used for the high-efficiency and miniaturized requirements of the power supply.

However, both the planar transformer and the planar boost inductor have the characteristic that the air-gap inductance affects the winding loss. Since the edge magnetic flux and bypass magnetic flux cut the winding, eddy currents are generated on the windings, and the generated eddy currents will cause uneven distribution of current density inside the windings, resulting in an increase in AC resistance and an increase in winding loss.

Therefore, how to design a planar transformer to solve the problems and technical bottlenecks in the existing technology has become a critical topic in this field.

### SUMMARY

An objective of the present disclosure is to provide a planar transformer includes a first magnetic core, a second magnetic core, and a circuit board. The first magnetic core includes a base, a first magnetic column, a second magnetic column, and a third magnetic column, and the first magnetic column, the second magnetic column, and the third magnetic column form on a top surface of the base. The circuit board includes a first side, a second side, and a through hole. The through hole is sleeved on the second magnetic column, and the first side and the second side are protruding from the first magnetic core. The first magnetic core is connected with the second magnetic core, and the circuit board is disposed between the first magnetic core and the second magnetic core. At least one separation component is disposed between the first magnetic core and the second magnetic core, or the first magnetic core and/or the second magnetic core have a plurality of separation components.

In one embodiment, each separation component is made of electrical insulation material.

In one embodiment, a distance between the first magnetic column and the second magnetic column is equal to a distance between the second magnetic column and the third magnetic column.

In one embodiment, the circuit board further includes a first notch and a second notch. The first magnetic column and the third magnetic column are respectively embedded in the first notch and the second notch. An outer edge of the first magnetic column, a first edge of the first side, and a first edge of the second side are substantially along a straight line. An outer edge of the third magnetic column, a second edge of the first side, and a second edge of the second side are substantially along a straight line.

In one embodiment, the number of the at least one separation component is one, and the separation component is disposed between the second magnetic column and the second magnetic core.

In one embodiment, the number of the at least one separation component is plural, and the separation components are disposed between the second magnetic column and the second magnetic core, and in the second magnetic column.

In one embodiment, the number of the at least one separation component is plural, and the separation components are respectively symmetrically disposed between the first magnetic column and the second magnetic core, and between the third magnetic column and the second magnetic core.

In one embodiment, the number of the at least one separation component is plural, and the separation components are respectively symmetrically disposed between the first magnetic column and the second magnetic core, between the third magnetic column and the second magnetic core, and in the first magnetic column and in the third magnetic column.

In one embodiment, the number of the at least one separation component is plural, and the separation components are respectively symmetrically disposed between the first magnetic column and the second magnetic core, between the second magnetic column and the second magnetic core, and between the third magnetic column and the second magnetic core.

In one embodiment, the number of the at least one separation component is plural, and the separation components are respectively symmetrically disposed between the first magnetic column and the second magnetic core, between the second magnetic column and the second magnetic core, between the third magnetic column and the second magnetic core, and in the first magnetic column, in the second magnetic column, and in the third magnetic column.

In one embodiment, the number of the at least one separation component is plural, and the separation components are symmetrically disposed in the second magnetic core.

In one embodiment, the number of the at least one separation component is plural, and the separation components are symmetrically disposed in the first magnetic core.

In one embodiment, the number of the at least one separation component is plural, and the separation components are symmetrically disposed in the first magnetic core and in the second magnetic core.

In one embodiment, the first magnetic core is an E-shaped magnetic core, and the second magnetic core is an I-shaped magnetic core.

In one embodiment, a thickness of each separation component is 0.07-0.08 mm.

Accordingly, the planar transformer proposed by the present disclosure has the following characteristics and advantages: 1. the planar transformer is used to significantly increase the power density of the power converter; 2. the structure of the planar transformer can reduce the leakage inductance and reduce the voltage stress of the power switch; 3. the planar transformer has the characteristics of high temperature resistance and easy heat dissipation, and therefore it is widely used for the high-efficiency and miniaturized requirements of the power supply; 4. the planar transformer of the present disclosure reduces the air-gap magnetic flux cutting the windings (that is, reduces the edge magnetic flux) by adjusting the number, size, and location of the separation components, thereby reducing winding loss (mainly copper loss) and increasing efficiency.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a perspective view of a first magnetic core of a planar transformer according to the present disclosure.

FIG. 2 is a perspective view of a circuit board of the planar transformer according to the present disclosure.

FIG. 3 is a perspective view of disposing the circuit board on the first magnetic core according to the present disclosure.

FIG. 4 is a perspective view of disposing a second magnetic core on the first magnetic core according to the present disclosure.

FIG. 5 is a side view of at least one separation component of the planar transformer according to a first embodiment of the present disclosure.

FIG. 6 is a side view of at least one separation component of the planar transformer according to a second embodiment of the present disclosure.

FIG. 7 is a side view of at least one separation component of the planar transformer according to a third embodiment of the present disclosure.

FIG. 8 is a side view of at least one separation component of the planar transformer according to a fourth embodiment of the present disclosure.

FIG. 9 is a side view of at least one separation component of the planar transformer according to a fifth embodiment of the present disclosure.

FIG. 10 is a side view of at least one separation component of the planar transformer according to a sixth embodiment of the present disclosure.

FIG. 11 is a side view of at least one separation component of the planar transformer according to a seventh embodiment of the present disclosure.

FIG. 12 is a side view of at least one separation component of the planar transformer according to an eight embodiment of the present disclosure.

FIG. 13 is a side view of at least one separation component of the planar transformer according to a ninth embodiment of the present disclosure.

FIG. 14 is a side view of at least one separation component of the planar transformer according to a tenth embodiment of the present disclosure.

FIG. 15 is a side view of at least one separation component of the planar transformer according to an eleventh embodiment of the present disclosure.

FIG. 16 is a side view of at least one separation component of the planar transformer according to a twelfth embodiment of the present disclosure.

### DETAILED DESCRIPTION

Reference will now be made to the drawing figures to describe the present disclosure in detail. It will be understood that the drawing figures and exemplified embodiments of present disclosure are not limited to the details thereof.

The implementation of the present disclosure is described below through specific examples, and those who are familiar with this technology can easily understand other advantages and effects of the present disclosure from the content disclosed in this specification. The present disclosure can also be implemented or applied through other different specific examples, and the details in the present disclosure can also be modified and changed based on different viewpoints and applications without departing from the spirit of the present disclosure.

The structures, proportions, sizes, and number of components shown in the drawings attached to the present disclosure are only used to match the content in the present disclosure, for those who are familiar with this technology to understand and read, and are not used to limit the implementation of the present disclosure. Any modification of structure, change of proportional relationship or adjustment of size shall fall within the scope covered by the technical content disclosed in the present disclosure, provided that it does not affect the effect and purpose of the present disclosure.

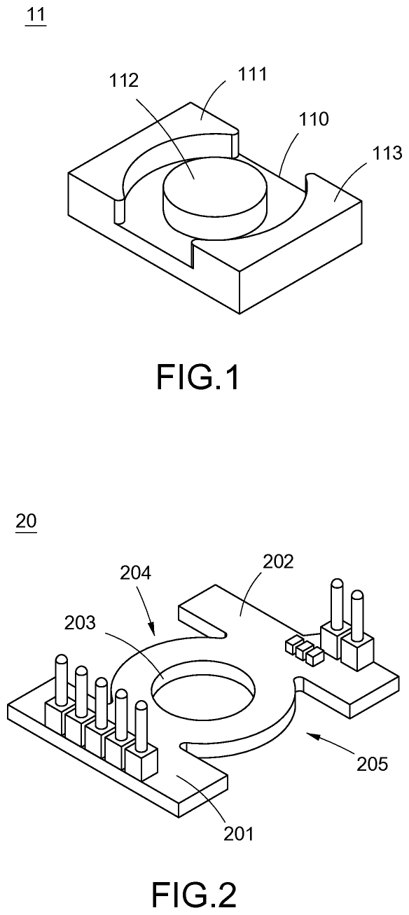

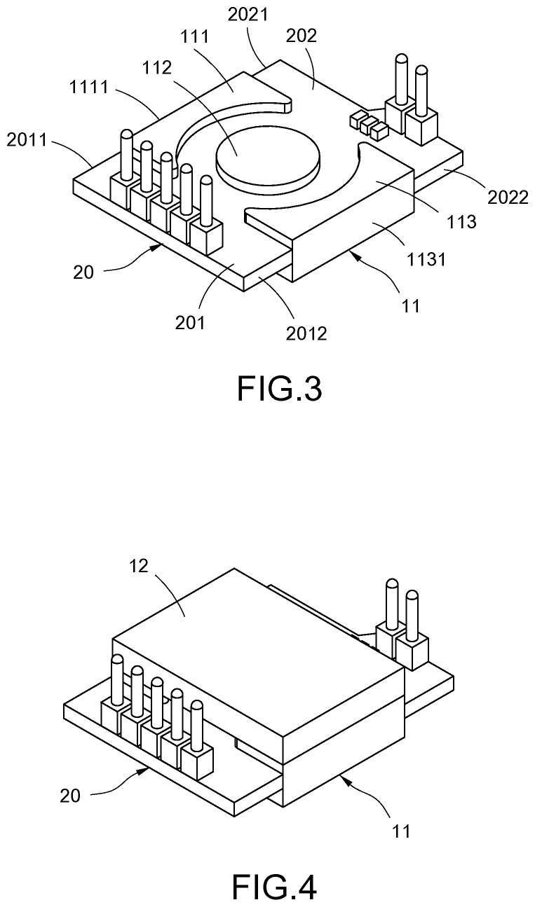

Please refer to FIG. 1 to FIG. 4, which show a perspective view of a first magnetic core of a planar transformer, a perspective view of a circuit board of the planar transformer, a perspective view of disposing the circuit board on the first magnetic core, and a perspective view of disposing a second magnetic core on the first magnetic core according to the present disclosure, respectively. The planar transformer includes a first magnetic core 11, a second magnetic core 12, and a circuit board 20.

The first magnetic core 11 includes a base 110, a first magnetic column 111, a second magnetic column 112, and a third magnetic column 113. The first magnetic column 111, the second magnetic column 112, and the third magnetic column 113 form on a top surface of the base 110. In one embodiment, a distance between the first magnetic column 111 and the second magnetic column 112 is equal to a distance between the second magnetic column and the third magnetic column, and with the center of the second magnetic column 112, the first magnetic core 11 is a symmetrical magnetic core.

The circuit board includes a first side 201, a second side 202, and a through hole 203.

The through hole 203 is sleeved on the second magnetic column 112, and the first side 201 and the second side 202 are protruding from the first magnetic core 11. The first magnetic core 11 is connected with the second magnetic core 12, and the circuit board 20 is disposed between the first magnetic core 11 and the second magnetic core 12.

The circuit board 20 further includes a first notch 204 and a second notch 205. The first magnetic column 111 and the third magnetic column 113 are respectively embedded in the first notch 204 and the second notch 205. An outer edge 1111 of the first magnetic column 1111, a first edge 2011 of the first side 201, and a first edge 2021 of the second side 202 are substantially along a straight line. An outer edge 1131 of the third magnetic column 113, a second edge 2012 of the first side 201, and a second edge 2022 of the second side 202 are substantially along a straight line.

At least one separation component 30 is disposed between the first magnetic core 11 and the second magnetic core 12, or the first magnetic core 11 and/or the second magnetic core 12 have a plurality of separation components 30. In the present disclosure, each separation component 30 is made of electrical insulation material, such as but not limited to, materials that can block the flow of electric charges, rubber-like polymer materials, plastic materials, polytetrafluoroethylene materials, etc.

The planar transformer of the present disclosure reduces the air-gap magnetic flux cutting the windings (that is, reduces the edge magnetic flux) by adjusting the number, size, and location of the separation components 30, thereby reducing winding loss (mainly copper loss) and increasing efficiency. In the following, different embodiments of the configuration of the separation components 30 will be described.

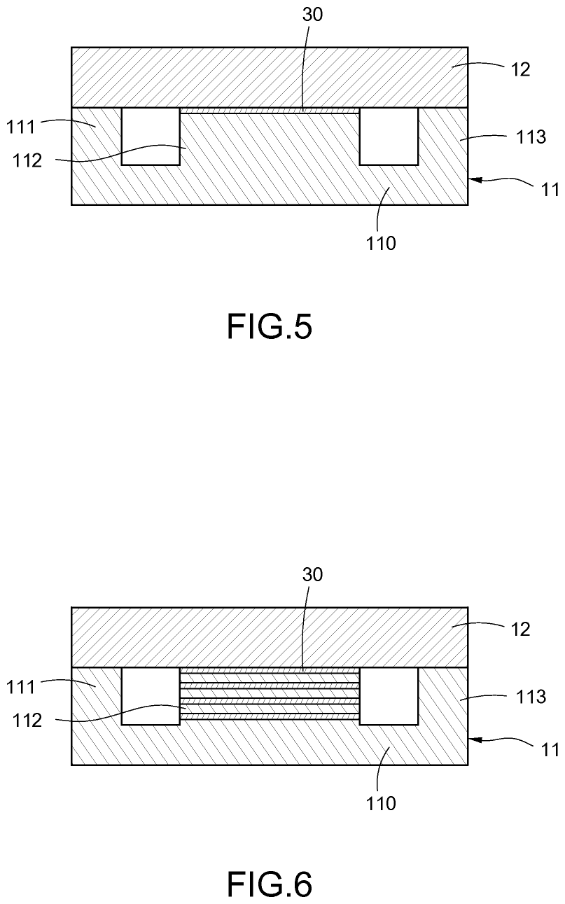

Please refer to FIG. 5 and FIG. 6, which respectively show a side view of at least one separation component of the planar transformer according to a first embodiment and a second embodiment of the present disclosure. For convenience, the circuit board 20 is omitted in figures. As shown in FIG. 5, the number of the at least one separation component 30 is one, and the separation component is disposed between the second magnetic column 112 and the second magnetic core 12. That is, the separation component 30 is formed on the second magnetic column 112, and by connecting the second magnetic core 12 to the first magnetic core 11, the separation component 30 is disposed between the second magnetic column 112 and the second magnetic core 12. In one preferred embodiment, a thickness of each separation component 30 is 0.07-0.08 mm.

As shown in FIG. 6, the number of the at least one separation component 30 is plural, such as but not limited to four, and the separation components 30 are disposed between the second magnetic column 112 and the second magnetic core 12, and in the second magnetic column 112. That is, the separation components 30 are formed on the second magnetic column 112 and in the second magnetic column 112, and by connecting the second magnetic core 12 to the first magnetic core 11, the separation components 30 are disposed between the second magnetic column 112 and the second magnetic core 12, and in the second magnetic column 112. In one preferred embodiment, a thickness of each separation component 30 is 0.07-0.08 mm.

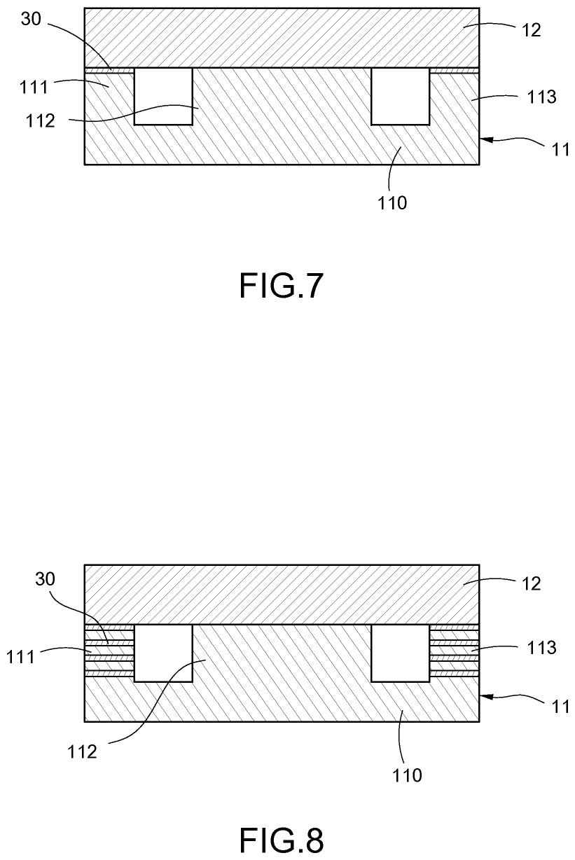

Please refer to FIG. 7 and FIG. 8, which respectively show a side view of at least one separation component of the planar transformer according to a third embodiment and a fourth embodiment of the present disclosure. As shown in FIG. 7, the number of the at least one separation component 30 is plural, such as but not limited to two, and one of the separation components 30 is disposed between the first magnetic column 111 and the second magnetic core 12, and the other of the separation components 30 is disposed between the third magnetic column 113 and the second magnetic core 12. That is, the two separation components 30 are respectively formed on the first magnetic column 111 and on the third magnetic column 113, and by connecting the second magnetic core 12 to the first magnetic core 11, the separation components 30 are disposed between the first magnetic column 111 and the second magnetic core 12, and between the third magnetic column 113 and the second magnetic core 12.

As shown in FIG. 8, the number of the at least one separation component 30 is plural, such as but not limited to eight, and the separation components 30 are disposed between the first magnetic column 111 and the second magnetic core 12, between the three magnetic column 113 and the second magnetic core 12, and in the first magnetic column 111 and in the third magnetic column 113. That is, the eight separation components 30 are respectively formed on the first magnetic column 111 and in the first magnetic column 111, and on the third magnetic column 113 and in the third magnetic column 113, and by connecting the second magnetic core 12 to the first magnetic core 11, the separation components 30 are disposed between the first magnetic column 111 and the second magnetic core 12 and in the first magnetic column 111, and between the third magnetic column 113 and the second magnetic core 12 and in the third magnetic column 113.

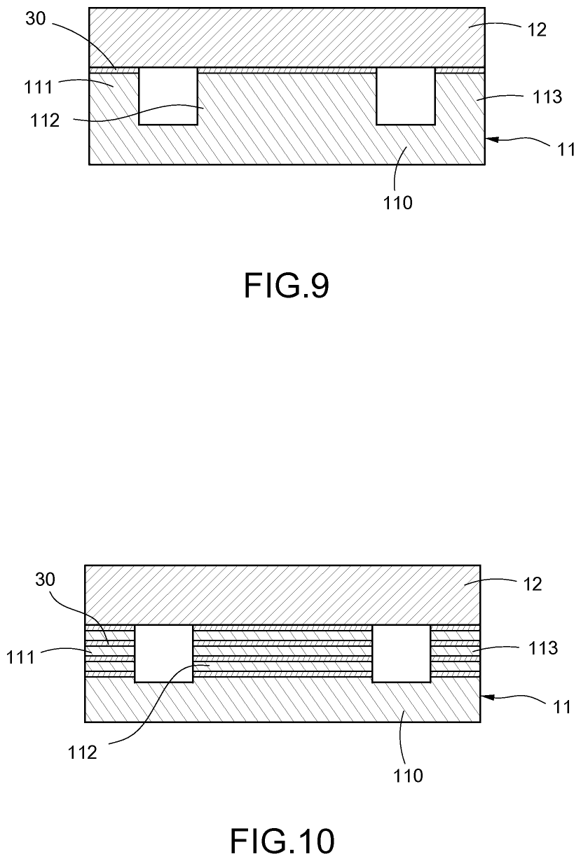

Please refer to FIG. 9 and FIG. 10, which respectively show a side view of at least one separation component of the planar transformer according to a fifth embodiment and a sixth embodiment of the present disclosure. As shown in FIG. 9, the number of the at least one separation component 30 is plural, such as but not limited to three, and the first one of the separation components 30 is disposed between the first magnetic column 111 and the second magnetic core 12, the second one of the separation components 30 is disposed between the second magnetic column 112 and the second magnetic core 12, and the third one of the separation components is disposed between the third magnetic column 113 and the second magnetic core 12. That is, the three separation components 30 are respectively formed on the first magnetic column 111, on the second magnetic column 112, and on the third magnetic column 113, and by connecting the second magnetic core 12 to the first magnetic core 11, the separation components 30 are disposed between the first magnetic column 111 and the second magnetic core 12, between the second magnetic column 112 and the second magnetic core 12, and between the third magnetic column 113 and the second magnetic core 12.

As shown in FIG. 10, the number of the at least one separation component 30 is plural, such as but not limited to twelve, and the separation components 30 are disposed between the first magnetic column 111 and the second magnetic core 12, between the second magnetic column 112 and the second magnetic core 12, between the three magnetic column 113 and the second magnetic core 12, and in the first magnetic column 111, in the second magnetic column 112, and in the third magnetic column 113. That is, the twelve separation components 30 are respectively formed on the first magnetic column 111 and in the first magnetic column 111, on the second magnetic column 112 and in the second magnetic column 112, and on the third magnetic column 113 and in the third magnetic column 113, and by connecting the second magnetic core 12 to the first magnetic core 11, the separation components 30 are disposed between the first magnetic column 111 and the second magnetic core 12 and in the first magnetic column 111, between the second magnetic column 112 and the second magnetic core 12 and in the second magnetic column 112, and between the third magnetic column 113 and the second magnetic core 12 and in the third magnetic column 113.

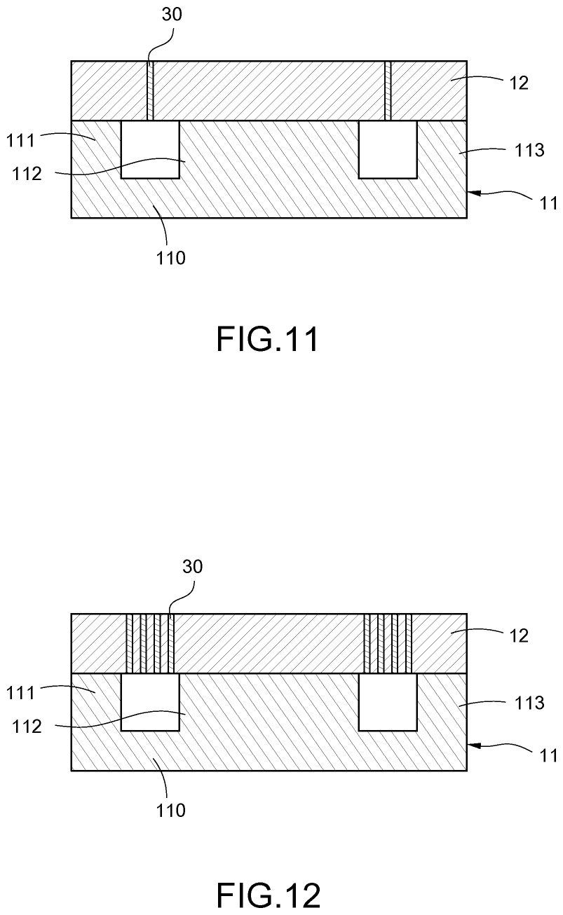

Please refer to FIG. 11 and FIG. 12, which respectively show a side view of at least one separation component of the planar transformer according to a seventh embodiment and an eight embodiment of the present disclosure. As shown in FIG. 11, the number of the at least one separation component 30 is plural, such as but not limited to two, and one of the separation components 30 is disposed in one side of the second magnetic core 12, and the other of the separation components 30 is disposed in the other side of the second magnetic core 12. That is, the two separation components 30 form in the second magnetic core 12, and by connecting the second magnetic core 12 to the first magnetic core 11, one of the separation components 30 is disposed in the second magnetic core 12 corresponding to the base 110 between the first magnetic column 111 and the second magnetic column 112, and the other of the separation components 30 is disposed in the second magnetic core 12 corresponding to the base 110 between the second magnetic column 112 and the third magnetic column 113.

As shown in FIG. 12, the number of the at least one separation component 30 is plural, such as but not limited to eight, and four of the separation components 30 are disposed in one side of the second magnetic core 12, and the other four of the separation components 30 are disposed in the other side of the second magnetic core 12. That is, the eight separation components 30 form in the second magnetic core 12, and by connecting the second magnetic core 12 to the first magnetic core 11, four of the separation components 30 are disposed in the second magnetic core 12 corresponding to the base 110 between the first magnetic column 111 and the second magnetic column 112, and the other four of the separation components 30 are disposed in the second magnetic core 12 corresponding to the base 110 between the second magnetic column 112 and the third magnetic column 113.

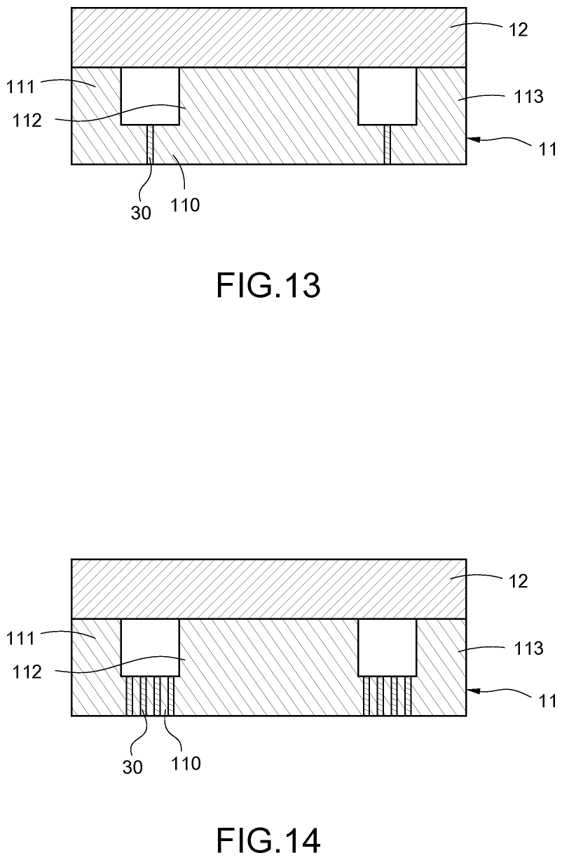

Please refer to FIG. 13 and FIG. 14, which respectively show a side view of at least one separation component of the planar transformer according to a ninth embodiment and a tenth embodiment of the present disclosure. As shown in FIG. 13, the number of the at least one separation component 30 is plural, such as but not limited to two, and one of the separation components 30 is disposed in one side of the first magnetic core 11, and the other of the separation components 30 is disposed in the other side of the first magnetic core 11. That is, the two separation components 30 form in the first magnetic core 11, and by connecting the second magnetic core 12 to the first magnetic core 11, one of the separation components 30 is disposed in the first magnetic core 11 corresponding to the base 110 between the first magnetic column 111 and the second magnetic column 112, and the other of the separation components 30 is disposed in the first magnetic core 11 corresponding to the base 110 between the second magnetic column 112 and the third magnetic column 113.

As shown in FIG. 14, the number of the at least one separation component 30 is plural, such as but not limited to eight, and four of the separation components 30 are disposed in one side of the first magnetic core 11, and the other four of the separation components 30 are disposed in the other side of the first magnetic core 11. That is, the eight separation components 30 form in the first magnetic core 11, and by connecting the second magnetic core 12 to the first magnetic core 11, four of the separation components 30 are disposed in the first magnetic core 11 corresponding to the base 110 between the first magnetic column 111 and the second magnetic column 112, and the other four of the separation components 30 are disposed in the first magnetic core 11 corresponding to the base 110 between the second magnetic column 112 and the third magnetic column 113.

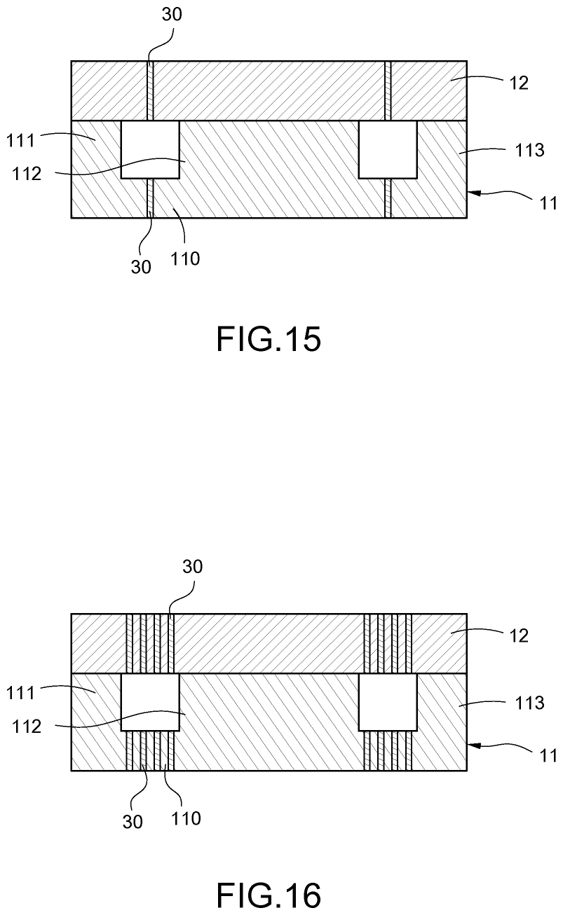

Please refer to FIG. 15 and FIG. 16, which respectively show a side view of at least one separation component of the planar transformer according to an eleventh embodiment and a twelfth embodiment of the present disclosure. As shown in FIG. 15, the number of the at least one separation component 30 is plural, such as but not limited to four, and two of the separation components 30 are disposed in one side of the first magnetic core 11 and in the other side of the first magnetic core 11 respectively, and the other two of the separation components 30 are disposed in one side of the second magnetic core 12 and in the other side of the second magnetic core 12 respectively. That is, the two separation components 30 form in the first magnetic core 11, and by connecting the second magnetic core 12 to the first magnetic core 11, one of the separation components 30 is disposed in the first magnetic core 11 corresponding to the base 110 between the first magnetic column 111 and the second magnetic column 112, and the other of the separation components 30 is disposed in the first magnetic core 11 corresponding to the base 110 between the second magnetic column 112 and the third magnetic column 113; the other two separation components 30 form in the second magnetic core 12, and by connecting the second magnetic core 12 to the first magnetic core 11, one of the separation components 30 is disposed in the second magnetic core 12 corresponding to the base 110 between the first magnetic column 111 and the second magnetic column 112, and the other of the separation components 30 is disposed in the second magnetic core 12 corresponding to the base 110 between the second magnetic column 112 and the third magnetic column 113. In one preferred embodiment, the two separation components 30 disposed in the first magnetic core 11 are corresponding to the two separation components 30 disposed in the second magnetic core 12.

As shown in FIG. 16, the number of the at least one separation component 30 is plural, such as but not limited to sixteen, and eight of the separation components 30 are disposed in one side of the first magnetic core 11 and in the other side of the first magnetic core 11 respectively, and the other eight of the separation components 30 are disposed in one side of the second magnetic core 12 and in the other side of the second magnetic core 12 respectively. That is, the eight separation components 30 form in the first magnetic core 11, and by connecting the second magnetic core 12 to the first magnetic core 11, four of the separation components 30 are disposed in the first magnetic core 11 corresponding to the base 110 between the first magnetic column 111 and the second magnetic column 112, and the other fourth of the separation components 30 is disposed in the first magnetic core 11 corresponding to the base 110 between the second magnetic column 112 and the third magnetic column 113; the other eight separation components 30 form in the second magnetic core 12, and by connecting the second magnetic core 12 to the first magnetic core 11, four of the separation components 30 are disposed in the second magnetic core 12 corresponding to the base 110 between the first magnetic column 111 and the second magnetic column 112, and the other four of the separation components 30 are disposed in the second magnetic core 12 corresponding to the base 110 between the second magnetic column 112 and the third magnetic column 113. In one preferred embodiment, the eight separation components 30 disposed in the first magnetic core 11 are corresponding to the eight separation components 30 disposed in the second magnetic core 12.

In summary, the present disclosure has the following features and advantages:
1. The planar transformer is used to significantly increase the power density of the power converter.
2. The structure of the planar transformer can reduce the leakage inductance and reduce the voltage stress of the power switch.
3. The planar transformer has the characteristics of high temperature resistance and easy heat dissipation, and therefore it is widely used for the high-efficiency and miniaturized requirements of the power supply.
4. The planar transformer of the present disclosure reduces the air-gap magnetic flux cutting the windings (that is, reduces the edge magnetic flux) by adjusting the number, size, and location of the separation components, thereby reducing winding loss (mainly copper loss) and increasing efficiency.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A planar transformer, comprising:
a first magnetic core and a second magnetic core, wherein the first magnetic core comprises a base, a first magnetic column, a second magnetic column, and a third magnetic column, and the first magnetic column, the second magnetic column, and the third magnetic column form on a top surface of the base, and
a circuit board, comprising a first side, a second side, and a through hole,
wherein the through hole is sleeved on the second magnetic column, and the first side and the second side are protruding from the first magnetic core,
wherein the first magnetic core is connected with the second magnetic core, and the circuit board is disposed between the first magnetic core and the second magnetic core,
wherein at least one separation component is disposed between the first magnetic core and the second magnetic core, or the first magnetic core and/or the second magnetic core have a plurality of separation components.

2. The planar transformer as claimed in claim 1, wherein each separation component is made of electrical insulation material.

3. The planar transformer as claimed in claim 1, wherein a distance between the first magnetic column and the second magnetic column is equal to a distance between the second magnetic column and the third magnetic column.

4. The planar transformer as claimed in claim 1, wherein the circuit board further comprises:
a first notch and a second notch,
wherein the first magnetic column and the third magnetic column are respectively embedded in the first notch and the second notch,
wherein an outer edge of the first magnetic column, a first edge of the first side, and a first edge of the second side are substantially along a straight line,
wherein an outer edge of the third magnetic column, a second edge of the first side, and a second edge of the second side are substantially along a straight line.

5. The planar transformer as claimed in claim 1, wherein the number of the at least one separation component is one, and the separation component is disposed between the second magnetic column and the second magnetic core.

6. The planar transformer as claimed in claim 1, wherein the number of the at least one separation component is plural, and the separation components are disposed between the second magnetic column and the second magnetic core, and in the second magnetic column.

7. The planar transformer as claimed in claim 1, wherein the number of the at least one separation component is plural, and the separation components are respectively symmetrically disposed between the first magnetic column and the second magnetic core, and between the third magnetic column and the second magnetic core.

8. The planar transformer as claimed in claim 1, wherein the number of the at least one separation component is plural, and the separation components are respectively symmetrically disposed between the first magnetic column and the second magnetic core, between the third magnetic column and the second magnetic core, and in the first magnetic column and in the third magnetic column.

9. The planar transformer as claimed in claim 1, wherein the number of the at least one separation component is plural, and the separation components are respectively symmetrically disposed between the first magnetic column and the second magnetic core, between the second magnetic column and the second magnetic core, and between the third magnetic column and the second magnetic core.

10. The planar transformer as claimed in claim 1, wherein the number of the at least one separation component is plural, and the separation components are respectively symmetrically disposed between the first magnetic column and the second magnetic core, between the second magnetic column and the second magnetic core, between the third magnetic column and the second magnetic core, and in the first magnetic column, in the second magnetic column, and in the third magnetic column.

11. The planar transformer as claimed in claim 1, wherein the number of the at least one separation component is plural, and the separation components are symmetrically disposed in the second magnetic core.

12. The planar transformer as claimed in claim 1, wherein the number of the at least one separation component is plural, and the separation components are symmetrically disposed in the first magnetic core.

13. The planar transformer as claimed in claim 1, wherein the number of the at least one separation component is plural, and the separation components are symmetrically disposed in the first magnetic core and in the second magnetic core.

14. The planar transformer as claimed in claim 1, wherein the first magnetic core is an E-shaped magnetic core, and the second magnetic core is an I-shaped magnetic core.

15. The planar transformer as claimed in claim 1, wherein a thickness of each separation component is 0.07-0.08 mm.
